(19) United States
(12) Patent Application Publication
(10) Pub. No.: US 2026/0167505 A1
(43) Pub. Date: Jun. 18, 2026

(54) ORGANOSILICA SOL AND PRODUCTION METHOD THEREFOR

(71) Applicant: NISSAN CHEMICAL CORPORATION, Tokyo (JP)

(72) Inventors: Takeshi NAKADA, Sodegaura-shi (JP); Megumi ARAKI, Sodegaura-shi (JP); Masatoshi SUGISAWA, Sodegaura-shi (JP); Kazuya EBARA, Sodegaura-shi (JP); Yuki MATSUYAMA, Sodegaura-shi (JP)

(73) Assignee: NISSAN CHEMICAL CORPORATION, Tokyo (JP)

(21) Appl. No.: 19/126,110

(22) PCT Filed: Oct. 18, 2023
(86) PCT No.: PCT/JP2023/037726

§ 371 Date: Apr. 30, 2025

(30) Foreign Application Priority Data
Oct. 31, 2022 (JP) 2022-174507

(51) Int. Cl. C01B 33/145; C08K 9/06

(52) U.S. Cl. CPC C01B 33/145; C08K 9/06; C01P 2004/64; C01P 2006/12; C01P 2006/82; C08K 2201/003; C08K 2201/006

(57) ABSTRACT

A silica particle dispersion in which surface-treated silica particles are dispersed in an organic solvent, wherein the surface-treated silica particles are silica particles surface-treated with a surface treatment agent including an alkoxysilane containing a radically polymerizable double bond and an ester group, and wherein a change rate over time in amount of particle surface treatment with the surface treatment agent is less than 20%, and a decomposition rate of the surface treatment agent is 2.0% or less, a method for producing the silica particle dispersion, and a composite material including the silica particle dispersion.

### TECHNICAL FIELD

The present invention relates to an organosilica sol and a method for producing the same.

### BACKGROUND ART

Composite materials are known that are made by incorporating inorganic oxide particles such as silica into various resins to improve mechanical properties such as strength and elastic modulus, as well as thermal and electrical properties.

In order to improve the properties of the composite materials, attention has also been focused on control of the particle interface, such as the compatibility between the silica particles or the like and the resin to be incorporated, and there have been proposals for surface modification or the like of silica particles using various surface treatment agents (also called surface modifiers).

For example, in order to provide an organic solvent-dispersed inorganic oxide sol that has good dispersibility, low viscosity, excellent transparency, and good compatibility with resin solutions, a method has been disclosed in which hydroxyl groups on the surfaces of inorganic oxide particles such as silica are reacted with an alcohol to introduce alkoxysilyl groups to make the surfaces of the inorganic oxide particles organic, thus obtaining an inorganic oxide sol dispersed in an organic solvent such as toluene (Patent Document 1).

In addition, a liquid epoxy resin forming composition has been disclosed that contains a colloidal silica sol whose particle surface is coated with an organoalkoxysilane by, for example, subjecting a methanol-dispersed silica sol to solvent replacement with acetonitrile to obtain a silica sol dispersed in an acetonitrile-methanol mixed solvent, and then reacting the silica sol with phenyltrimethoxysilane (Patent Document 2).

In addition, a silica sol in which the surfaces of silica particles have been modified with an aluminum compound has been disclosed, the silica sol having excellent dispersion stability in an acidic region, having excellent stability and transparency in a coating composition containing the silica sol with a binder component, and having improved transparency, film hardness, scratch resistance, adhesion, heat resistance, impact resistance, and the like in a coating film of the coating composition (Patent Document 3).

### PRIOR ART DOCUMENTS

### Patent Documents

Patent Document 1: JP 2005-200294 A
Patent Document 2: WO 2009/008509
Patent Document 3: JP 2011-026183 A

### SUMMARY OF THE INVENTION

### Problem to be Solved by the Invention

The surface-treated silica particles described above can be used for forming a composite with the resin material, for example, in the form of a dispersion of the surface-treated silica particles or a sol of surface-treated silica. It is desired that the silica particle dispersion (silica sol) has, for example, good compatibility with the resin material, and that the quality of the surface-treated silica particles in the composite formation is constant after the production until its use, i.e., the state of the surface treatment of the particles (interface state of the particles) is constant, and the quality of the surface treatment is stable. If the state of the surface treatment of the surface-treated silica particles changes over time, this may hinder the stabilization of the quality of the surface-treated silica particles, and further, the stabilization of the quality of the surface-treated silica particles when formed into a composite material.

In view of the above circumstances, an object of the present invention is to provide a silica particle dispersion that exhibits little change over time related to the surface treatment and is stable in quality.

### Means for Solving the Problem

As a first aspect, an embodiment of the present invention for solving the problem described above relates to a silica particle dispersion in which surface-treated silica particles are dispersed in an organic solvent,
wherein the surface-treated silica particles are silica particles surface-treated with a surface treatment agent including an alkoxysilane containing a radically polymerizable double bond and an ester group, and
wherein in the dispersion,
a change rate over time in amount of particle surface treatment with the surface treatment agent as defined by the following Formula (1) is less than 20%, and a decomposition rate of the surface treatment agent as defined by the following Formula (2) is 2.00% or less:

$$〈 Change Rate [ \% ] over Time in Amount of Particle Surface Treatment 〉$$

$$change rate over time in amount of \\ particle surface treatment = [ ( B - A ) / A ] \times 100 [ \% ] \qquad Formula ( 1 )$$

in Formula (1),
A is an amount of particle surface treatment after one week of storage at room temperature (20 to 25° C.), following preparation of the silica particle dispersion; and
B is an amount of particle surface treatment after 14 weeks of storage at room temperature (20 to 25° C.), following preparation of the silica particle dispersion;

$$〈 Decomposition Rate [ \% ] of Surface Treatment Agent 〉$$

$$decomposition rate of the surface treatment agent = [ C \times ( D / E ) \div F ] \times 100 [ \% ] \qquad Formula ( 2 )$$

in Formula (2),
C is an amount (% by mass) of a decomposition product derived from the surface treatment agent in the silica particle dispersion after at least two weeks of storage at room temperature (20 to 25° C.) to 50° C., following preparation of the silica particle dispersion, in which the decomposition product includes a radically polymerizable double bond-containing carboxylic acid and a derivative of the radically polymerizable double bond-containing carboxylic acid;
D is a molecular weight (g/mol) of the surface treatment agent;
E is a molecular weight (g/mol) of the decomposition product; and
F is an amount (proportion in % by mass in the silica particle dispersion) of the surface treatment agent added during surface treatment.

A second aspect relates to the silica particle dispersion according to the first aspect, wherein the silica particle dispersion has a pH of 6.5 to 8.0.

A third aspect relates to the silica particle dispersion according to the second aspect, wherein the silica particle dispersion contains a basic substance selected from hydroxide or alkoxide compounds derived from monovalent alkali metals.

A fourth aspect relates to the silica particle dispersion according to any one of the first to third aspects, wherein an initial reaction rate between the surface treatment agent and the silica particles is 50% or more, the initial reaction rate being defined as a ratio of the amount of particle surface treatment with the surface treatment agent after one week of storage at room temperature (20 to 25° C.) following preparation of the silica particle dispersion, relative to the amount of the surface treatment agent added during surface treatment.

A fifth aspect relates to the silica particle dispersion according to any one of the first to fourth aspects,
wherein the silica particles have an average primary particle diameter of 5 nm or more and less than 100 nm, and
wherein in the silica particle dispersion, a concentration of the surface-treated silica particles is 20 to 70% by mass, and a water concentration is 0.001 to 10% by mass.

A sixth aspect relates to the silica particle dispersion according to any one of the first to fifth aspects, wherein the surface-treated silica particles are surface-treated with the surface treatment agent in an amount of 0.5 to 3.0 molecules per nm² of a surface area of the silica particles.

A seventh aspect relates to the silica particle dispersion according to any one of the first to sixth aspects, wherein the surface treatment agent is an alkoxysilane of the following Formula (a).

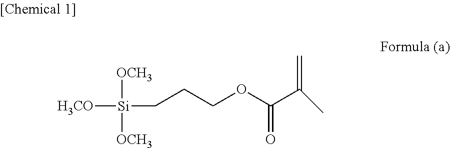 [SMILES: C=C(C)C(=O)OCCC[Si](OC)(OC)OC]

An eighth aspect relates to the silica particle dispersion according to any one of the first to seventh aspects, wherein the organic solvent is at least one organic solvent selected from the group consisting of alcohols, ketones, hydrocarbons, amides, esters, ethers, and amines.

A ninth aspect relates to a composite material comprising the silica particle dispersion according to any one of the first to eighth aspects and an organic resin material.

A tenth aspect relates to the composite material according to the ninth aspect, wherein the organic resin material is at least one selected from the group consisting of polyethylene resins, polypropylene resins, polystyrene resins, acrylic resins, urethane resins, urethane acrylate resins, polycarbonate resins, ABS resins, diallyl phthalate, and unsaturated polyesters.

An eleventh aspect relates to a composition comprising the silica particle dispersion according to any one of the first to eighth aspects, a photosensitive resin, and a photopolymerization initiator.

A twelfth aspect relates to the composition according to the eleventh aspect, wherein the photosensitive resin is at least one selected from the group consisting of acrylic resins, methacrylic resins, urethane acrylate resins, urethane methacrylate resins, and epoxy resins.

A thirteenth aspect relates to a method for producing a silica particle dispersion in which surface-treated silica particles are dispersed in an organic solvent, the method comprising the following steps (A), (B), and (C):
step (A): preparing a silica sol containing silica particles having an average primary particle diameter of 5 nm or more and less than 100 nm as a dispersoid, and a C₁₋₄ alcohol as a dispersion medium;
step (B): adding a surface treatment agent including an alkoxysilane containing a radically polymerizable double bond and an ester group to the silica sol, and stirring a mixture with heating; and
step (C): performing a pH adjustment to give a pH in a system of 6.5 to 8.0, and stirring the mixture with heating.

A fourteenth aspect relates to the method for producing a silica particle dispersion according to the thirteenth aspect, further comprising, after step (C), the following step (D):
step (D): adding a surface treatment agent including an alkoxysilane containing a radically polymerizable double bond and an ester group to the silica sol, and stirring the mixture with heating.

A fifteenth aspect relates to the method for producing a silica particle dispersion according to the thirteenth or fourteenth aspect,
wherein step (C) is the step of performing the pH adjustment by adding a basic substance selected from hydroxide or alkoxide compounds derived from monovalent alkali metals.

### Effects of the Invention

According to the present invention, it is possible to provide a silica particle dispersion in which surface-treated silica particles are dispersed in an organic solvent, the silica particle dispersion exhibiting little change over time related to the surface treatment (surface modification) and being stable in quality.

That is, according to the present invention, it is possible to provide a material that exhibits little change over time in the surface (interface) state and has a uniform quality in a composite material with a resin or the like.

### MODES FOR CARRYING OUT THE INVENTION

### [Silica Particle Dispersion]

The present invention is directed to a silica particle dispersion in which the below-described surface-treated silica particles are dispersed in an organic solvent.

The silica particle dispersion to which the present invention is directed is characterized in that the below-described change rate over time in amount of particle surface treatment is less than 20%, and the below-described decomposition rate of the surface treatment agent is 2.00% or less.

### <Surface-Treated Silica Particles>

The surface-treated silica particles according to the present invention are silica particles surface-treated with the below-described surface treatment agent.

As used herein, the term “surface treatment” includes both an embodiment in which at least a portion of the surfaces of the silica particles is coated with a surface treatment agent, and an embodiment in which at least a portion of the surface treatment agent is bonded to at least a portion of the surfaces of the silica particles. These embodiments are collectively referred to as the above-described “surface-treated silica particles”.

The phrase “at least a portion of the surfaces of the silica particles is coated with a surface treatment agent” may be any embodiment in which the below-described surface treatment agent coats at least a portion of the surfaces of the silica particles. That is, the phrase includes an embodiment in which the surface treatment agent covers a portion of the surfaces of the silica particles; and an embodiment in which the surface treatment agent covers the entire surfaces of the silica particles. In the embodiments, the surface treatment agent may or may not be bonded to the surfaces of the silica particles.

The phrase “at least a portion of the surface treatment agent is bonded to at least a portion of the surfaces of the silica particles” may be any embodiment in which the below-described surface treatment agent is bonded to at least a portion of the surfaces of the silica particles. That is, the phrase includes, for example, an embodiment in which the surface treatment agent is bonded to a portion of the surfaces of the silica particles; an embodiment in which the surface treatment agent is bonded to a portion of the surfaces of the silica particles to cover at least a portion of the surfaces; and an embodiment in which the surface treatment agent is bonded to the entire surfaces of the silica particles to cover the entire surfaces.

Hereinafter, preferred embodiments of the silica particles related to the surface-treated silica particles and the surface treatment agent will be described.

### <<Silica Particles>>

In the present invention, the silica particles related to the surface-treated silica particles (i.e., untreated silica particles, hereinafter simply referred to as the silica particles) may preferably have an average primary particle diameter of less than 100 nm, for example, 5 nm or more and less than 100 nm.

### <Average Primary Particle Diameter>

The average primary particle diameter of the silica particles according to the present invention may be a specific surface area diameter calculated from the specific surface area (S_{N2}) measured by the BET method using nitrogen gas as molecules adsorbed onto the particle surface.

The specific surface area diameter (average primary particle diameter: D (nm)) is the primary particle diameter calculated from the specific surface area S_{N2} (m²/g) measured by the nitrogen adsorption method (BET method) based on the formula D (nm)=2720/S, and means the particle diameter calculated in terms of spherical silica particles.

The silica particles according to the present invention preferably have an average primary particle diameter of less than 100 nm, and may have an average primary particle diameter in the range of, for example, 5 nm or more and less than 100 nm, 5 nm or more and 80 nm or less, or 5 nm or more and 50 nm or less.

By using the silica particles having an average primary particle diameter of less than 100 nm, the silica particles when formed into the surface-treated silica particles can be well dispersed in an organic solvent. Furthermore, when a composite material obtained using a dispersion of the surface-treated silica particles is molded, the molded composite material can exhibit less defects and high transparency.

The method for producing the (untreated) silica particles constituting the surface-treated silica particles is not particularly limited, but the silica particles are preferably heat-treated in water at 200 to 380° C. The heat treatment may be performed using a pressure-resistant vessel (autoclave).

### <<Surface Treatment Agent>>

The surface treatment agent includes an alkoxysilane containing a radically polymerizable double bond and an ester group.

Preferably, the surface treatment agent may be an alkoxysilane having an alkoxy group and a group containing a radically polymerizable double bond and an ester group. While the number of groups containing a radically polymerizable double bond and an ester group and the number of alkoxy groups are not particularly limited, the alkoxysilane preferably has 1 to 3 groups containing a radically polymerizable double bond and an ester group, and 1 to 3 alkoxy groups (provided that the total number of both groups is 4 or less), per silicon atom.

Examples of the radically polymerizable double bond include 1-propenyl group, 2-methyl-1-propenyl group, allyl group, methallyl group, vinyl group, and (meth)acryloyl group.

One example of the group containing a radically polymerizable double bond and an ester group is a (meth)acryloyloxy group.

The alkoxy group is preferably a C₁₋₃ alkoxy group, and particularly preferably a methoxy group.

In a preferred embodiment, the surface treatment agent may be an alkoxysilane (3-methacryloxypropyltrimethoxysilane) of the following Formula (a).

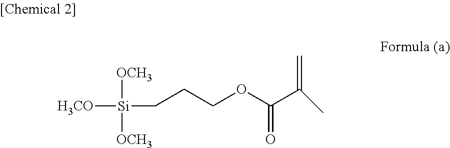 [SMILES: C=C(C)C(=O)OCCC[Si](OC)(OC)OC]

Specific examples of preferred surface treatment agents include, but are not limited to, 3-methacryloxypropylmethyldimethoxysilane, 3-methacryloxypropylmethyldiethoxysilane, 3-methacryloxypropyltriethoxysilane, 3-acryloxypropyltrimethoxysilane, 8-methacryloxyoctylmethyldimethoxysilane, and 8-methacryloxyoctyltrimethoxysilane.

An amount of surface treatment with the surface treatment agent, i.e., the amount of the surface treatment agent that coats the particle surface and/or is bonded to the particle surface, may be in the range of, for example, 0.5 to 3.0 molecules per nm² of the surface area of the silica particles. As used herein, the number of molecules per nm² of the surface area (amount of surface treatment) represents the total amount of the surface treatment agent required for the surface treatment, and is not intended to represent the amount of surface treatment with each individual surface treatment agent in the case where the surface treatment is performed with a plurality of types of surface treatment agents.

### <<Organic Solvent>>

In the silica particle dispersion of the present invention, the organic solvent serving as the dispersion medium is not particularly limited, but may be, for example, at least one organic solvent selected from alcohols, ketones, hydrocarbons, amides, ethers, esters, and amines.

Examples of the alcohols include C₁₋₅ alcohols, and specific examples thereof include methanol, ethanol, isopropyl alcohol, and n-butanol.

Examples of the ketones include C₁₋₅ ketones, and specific examples thereof include methyl ethyl ketone, methyl isobutyl ketone, γ-butyrolactone, N-methyl-2-pyrrolidone, and N-ethyl-2-pyrrolidone.

Examples of the hydrocarbons include toluene, xylene, n-pentane, n-hexane, and cyclohexane.

Examples of the amides include dimethylacetamide, N,N-dimethylformamide, dimethylacrylamide, acryloylmorpholine, and diethylacrylamide.

Examples of the ethers include ethylene glycol monomethyl ether and propylene glycol monomethyl ether.

Examples of the esters include ethyl acetate and butyl acetate.

Examples of the amines include triethylamine, tributylamine, N,N-dimethylaniline, pyridine, and picoline.

The content of the surface-treated silica particles in the dispersion may be expressed as a silica concentration.

The silica concentration may be calculated by measuring the content of calcination residue obtained after calcining the silica particle dispersion at 1000° C. The silica concentration in the silica particle dispersion may be, for example, 20% by mass to 70% by mass or 20% by mass to 60% by mass, or, for example, 30% by mass to 40% by mass.

The water content (water concentration) in the silica particle dispersion may be 20% by mass or less, for example, 0.001 to 10% by mass, or 0.1 to 5% by mass. Adjusting the water content to be in this range achieves good dispersion stability and facilitates obtaining a composite material with an organic resin material.

### <Change Rate Over Time>

Regarding the dispersion of the surface-treated silica particles, when the surface treatment agent used for the surface treatment remains in the system, the surface treatment agent may react with the surfaces of the silica particles over time, and the amount of surface treatment of the silica particles may change between immediately after the preparation of the dispersion and after the passage of time. This amount of change is referred to herein as the change rate over time in amount of particle surface treatment, and the change rate over time is defined by the following Formula (1):

$$〈 Change Rate [ \% ] over Time in Amount of Particle Surface Treatment 〉$$

$$change rate over time in amount of \\ particle surface treatment = [ ( B - A ) / A ] \times 100 [ \% ] \qquad Formula ( 1 )$$

in Formula (1), A is an amount of particle surface treatment after one week of storage at room temperature (20 to 25° C.), following preparation of the silica particle dispersion; and B is an amount of particle surface treatment after 14 weeks of storage at room temperature (20 to 25° C.), following preparation of the silica particle dispersion.

In the present invention, the change rate over time is less than 20%, i.e., the silica particle dispersion exhibits little variation in the amount of surface treatment after preparation, and thus, in the formation of a composite between the silica particle dispersion and a resin material, the silica particle dispersion has excellent compatibility with the resin, and, after the composite formation, the resulting composite material (product) is expected to have little variation in mechanical properties, such as elastic modulus, strength, and hardness.

The amount of particle surface treatment may be quantified as the content (%) of the surface treatment agent bonded to the particle surface, from the carbon content (%) quantified by elemental analysis of the surface-treated silica particles.

### <Decomposition Rate>

After preparation of a dispersion of the surface-treated silica particles, in the dispersion, the surface treatment agent used for the surface treatment may decompose over time due to the structure of the surface treatment agent.

In the present invention, the decomposition rate of the surface treatment agent is defined by the following Formula (2):

$$〈 Decomposition Rate [ \% ] of Surface Treatment Agent 〉$$

$$decomposition rate of the surface treatment agent = [ C \times ( D / E ) \div F ] \times 100 [ \% ] \qquad Formula ( 2 )$$

in Formula (2), C is an amount (% by mass) of a decomposition product derived from the surface treatment agent in the silica particle dispersion after at least two weeks of storage at room temperature (20 to 25° C.) to 50° C., following preparation of the silica particle dispersion; D is a molecular weight (g/mol) of the surface treatment agent; E is a molecular weight (g/mol) of the decomposition product; and F is an amount (proportion in % by mass in the silica particle dispersion) of the surface treatment agent added during surface treatment.

In the present invention, the decomposition rate is 2.00% or less, i.e., after preparation, the resulting silica particle dispersion has a small amount of decomposition of the surface treatment agent bonded to/coated on the silica particle surface, and thus, in the formation of a composite between the silica particle dispersion and a resin material, the resulting composite material (product) is expected to have little variation in physical properties, such as adhesion.

The decomposition product derived from the surface treatment agent includes acid compounds produced by hydrolysis of an ester portion of the alkoxysilane containing a radically polymerizable double bond and an ester group, which serves as the surface treatment agent, i.e., includes radically polymerizable double bond-containing carboxylic acids and derivatives thereof. Examples of the decomposition product include (meth)acrylic acid, and compounds derived from methacrylic acid and acrylic acid (such as methyl methacrylate).

### <Reaction Rate>

In a preferred embodiment, the dispersion of the surface-treated silica particles may have an initial reaction rate between the surface treatment agent and the silica particles of 5% or more, 10% or more, 30% or more, or 50% or more, and more preferably 60% or more, or 70% or more. In addition, the initial reaction rate between the surface treatment agent and the silica particles may be 100% or less, 95% or less, 90% or less, or 85% or less.

As used herein, the initial reaction rate between the surface treatment agent and the silica particles may be defined as a ratio of the amount of particle surface treatment with the surface treatment agent after one week of storage at room temperature (20 to 25° C.) following preparation of the silica particle dispersion, relative to the amount of the surface treatment agent added during surface treatment.

That is, the initial reaction rate between the surface treatment agent and the silica particles may be defined as the value obtained by dividing F [amount (proportion in % by mass in the silica particle dispersion) of the surface treatment agent added during surface treatment] in the Formula (2), by A [amount (%) of particle surface treatment after one week of storage at room temperature (20 to 25° C.), following preparation of the silica particle dispersion] in the Formula (1).

A higher reaction rate means a smaller amount of the surface treatment agent remaining unreacted in the system (in the dispersion).

### <pH Value of Silica Particle Dispersion>

The silica particle dispersion according to the present invention preferably has a pH of 6.5 to 8.0, for example, a pH of 6.5 to 7.5, or a pH of 7.0 to 7.5. When the silica particle dispersion has a pH of 6.5 to 8.0, hydrolysis or dehydration condensation of the surface treatment agent including an alkoxysilane does not proceed excessively, and reaction over time between the surface treatment agent and the silica particles contained in the silica particle dispersion can be inhibited, so that the change rate over time in amount of particle surface treatment can be reduced to less than 20%.

The pH of the silica particle dispersion may be determined by measuring the pH of a liquid obtained by mixing the silica particle dispersion, the dispersion medium (e.g., methanol) of the dispersion, and pure water in a mass ratio of 1:1:1, using a pH meter.

The silica particle dispersion according to the present invention can be used after preparation by adjusting the pH to a basic level of, for example, 9.0 to 10.0. The present invention is also directed to a basic silica particle dispersion thus adjusted to a basic pH.

The silica particle dispersion according to the present invention preferably contains an inorganic base, and preferably contains a basic substance selected from, for example, hydroxides or alkoxide compounds derived from monovalent alkali metals.

Examples of the hydroxides derived from monovalent alkali metals include lithium hydroxide, sodium hydroxide, and potassium hydroxide, and preferred examples include sodium hydroxide and potassium hydroxide. Examples of the alkoxide compounds derived from monovalent alkali metals include sodium methoxide, sodium ethoxide, potassium methoxide, potassium ethoxide, and potassium t-butoxide.

### [Method for Producing Silica Particle Dispersion]

The present invention is also directed to a method for producing a silica particle dispersion in which surface-treated silica particles are dispersed in an organic solvent.

The method for producing the dispersion also includes an embodiment of a method for producing the surface-treated silica particles, i.e., a method for treating the surfaces of the silica particles with the surface treatment agent (alkoxysilane containing a radically polymerizable double bond and an ester group). This method is not particularly limited, but, for example, the surface treatment agent may be added and mixed into an organic solvent dispersion of the (untreated) silica particles, which causes hydrolysis and condensation of the alkoxy group in the surface treatment agent, so that the silica particles are surface-treated.

The amount of the surface treatment agent added may be such that the surface is treated with, for example, about 0.5 to 3.0 molecules of the surface treatment agent per nm² of the surface area of the silica particles. For example, the surface treatment agent may be added in an amount of 0.5 to 2.5 molecules or 0.7 to 2.5 molecules per nm² of the surface area of the silica particles. As used herein, the amount of the surface treatment agent added refers to the total amount (number of molecules) of the surface treatment agent added. For example, when two types of surface treatment agents are added, the amount of the surface treatment agent added refers to the total amount (number of molecules) of the two types of surface treatment agents added. An excess of the surface treatment agent that does not contribute to the surface treatment may remain in the system after the surface treatment reaction.

The hydrolysis of the alkoxy group in the alkoxysilane containing a radically polymerizable double bond and an ester group, which serves as the surface treatment agent, may be complete or partial hydrolysis; however, water is required, and it is preferred to add about 1 mole or more of water per mole of the alkoxy group. Alternatively, water contained in the organic solvent may be used.

A catalyst may be used for the hydrolysis and condensation. As the hydrolysis catalyst, a chelate compound, an organic acid, an inorganic acid, an organic base, or an inorganic base may be used alone or in combination. More specifically, for example, an aqueous solution of hydrochloric acid, acetic acid, an aqueous solution of ammonia, or the like may be used.

For example, the surface-treated silica particles may be produced by a method including the step of mixing silica particles and the surface treatment agent in an organic solvent. The surface treatment agent may be the above-described surface treatment agent. The silica particles to be surface-treated are preferably silica particles that have been heat-treated in water at 200 to 380° C. using a pressure-resistant vessel (autoclave) or the like, as described above.

In the mixing step, the amount of the surface treatment agent added may be an amount such that the surface is treated with the surface treatment agent in a proportion of, for example, 0.5 to 3.0 molecules per nm² of the surface area of the silica particles. Specifically, the surface treatment agent may be added in a proportion of 0.5 to 2.5 molecules, 0.7 to 2.5 molecules or the like, per nm² of the surface area of the silica particles. The amount of the surface treatment agent added refers to the total amount of the surface treatment agent added. For example, when two types of surface treatment agents are added, the amount of the surface treatment agent added is taken as the total amount of the two types of surface treatment agents. The surface treatment agent may be added in divided portions. Excess of the surface treatment agent that does not contribute to the surface treatment may be present in the reaction system.

The organic solvent used in the mixing step may be an organic solvent containing an alcohol and/or a ketone-based solvent. Examples of the alcohol include C₁₋₅ alcohols, and specific examples thereof include methanol, ethanol, isopropyl alcohol, and n-butanol. Examples of the ketone-based solvent include C₁₋₅ ketone-based solvents, and specific examples thereof include methyl ethyl ketone, methyl isobutyl ketone, and γ-butyrolactone.

The mixing step is not particularly limited as long as the temperature is such that the hydrolysis and condensation reaction of the surface treatment agent proceeds. For example, the mixing step may be performed at a temperature of 20° C. or more and less than 120° C. From the viewpoint of reaction efficiency, the mixing step is preferably performed at around the boiling point of the organic solvent. For example, when the mixing step is performed using an organic solvent containing methanol, the mixing step is preferably performed at around 60 to 65° C. In order to minimize changes in the silica concentration and the surface treatment agent concentration during the mixing step, the reaction may be performed using an apparatus equipped with a reflux device or the like, as required. The mixing step may be performed a plurality of times at the same temperature, or may be performed a plurality of times at different temperatures.

The mixing step may be performed for 30 minutes to 24 hours, and is preferably performed for 24 hours or less from an industrial viewpoint.

The mixing step may also include the step of adjusting the pH with an inorganic base. This pH adjustment step may be performed at any one time or a plurality of times before, during, or after the mixing step, but is preferably performed after or during the mixing step.

Examples of the inorganic base include hydroxides derived from monovalent alkali metals, such as sodium hydroxide and potassium hydroxide, and alkoxide compounds derived from monovalent alkali metals, such as sodium methoxide, sodium ethoxide, and potassium t-butoxide. These inorganic bases may be used alone or in combinations of two or more.

The amount of the inorganic base added may be, for example, 0.001 to 5% by mass, or 0.01 to 1% by mass, based on the mass of the silica particles. By adding the inorganic base, the pH of the mixed solution can be adjusted to, for example, 6.0 to 8.5, for example, 6.5 to 7.5, or 7.0 to 7.5.

One specific example of the method for producing the silica particle dispersion according to the present invention may be a method including the following steps (A), (B), and (C), but is not limited to this method (steps):
step (A): preparing a silica sol containing silica particles having an average primary particle diameter of 5 nm or more and less than 100 nm as a dispersoid, and a C₁₋₄ alcohol as a dispersion medium;
step (B): adding a surface treatment agent including an alkoxysilane containing a radically polymerizable double bond and an ester group to the silica sol, and stirring the mixture with heating; and
step (C): performing a pH adjustment to give a pH in the system of 6.5 to 8.0, and stirring the mixture with heating.

In step (A), examples of the C₁₋₄ alcohol include methanol, ethanol, isopropyl alcohol, and n-butanol.

The silica sol prepared in step (A) may have a water content of, for example, about 0.1 to 2% by mass.

The silica sol prepared in step (A) may be a silica sol prepared by subjecting an aqueous silica sol hydrothermally synthesized at 200 to 380° C. and 2 MPa to 22 MPa to solvent replacement with the C₁₋₄ alcohol.

Step (B) is not particularly limited as long as the temperature is such that the hydrolysis and condensation reaction of the surface treatment agent including an alkoxysilane containing a radically polymerizable double bond and an ester group proceeds. From the viewpoint of reaction efficiency, step (B) is preferably performed at around the boiling point of the dispersion medium of the silica sol. For example, when step (B) is performed using a methanol sol of the silica particles, step (B) is preferably performed at around 60 to 65° C.

This step may be performed for 30 minutes to 24 hours, and is preferably performed for 24 hours or less from an industrial viewpoint.

This step may also be performed under reduced pressure.

From the viewpoint of reaction efficiency, step (B) is preferably performed under acidic conditions. For example, when the silica sol in step (A) is acidic, the silica sol may be directly subjected to step (B) without adjusting the pH of the silica sol.

Step (C) may be the step of performing the pH adjustment by adding a basic substance selected from hydroxide or alkoxide compounds derived from monovalent alkali metals.

Examples of the hydroxides derived from monovalent alkali metals include sodium hydroxide and potassium hydroxide, and examples of the alkoxide compounds derived from monovalent alkali metals include sodium methoxide, sodium ethoxide, and potassium t-butoxide.

In a preferred embodiment, the method may further include, after step (C), the following step (D): adding a surface treatment agent including an alkoxysilane containing a radically polymerizable double bond and an ester group to the silica sol, and stirring the mixture with heating.

The conditions for stirring with heating and the pressure conditions in this step are similar to those in step (B); however, there is no need to adjust the pH to an acidic level.

The silica particle dispersion in which surface-treated silica particles are dispersed in an organic solvent can be used as one component of the below-described composite material.

From the viewpoint of ease of production of the composite material, at least a portion of the organic solvent contained in the silica particle dispersion may be replaced with another organic solvent. The other organic solvent may be at least one or two or more selected from the group consisting of alcohols, ketones, hydrocarbons, amides, esters, ethers, and amines. The type of solvent used for the replacement is not particularly limited as long as the solvent is different from the organic solvent in the silica particle dispersion, and the solvent may be selected from the viewpoint of the solubility of the organic resin material used for the composite formation.

Examples of the other organic solvent include alcohols such as methanol, ethanol, isopropyl alcohol, and n-butanol; ketones such as methyl ethyl ketone, methyl isobutyl ketone, γ-butyl lactone, N-methyl-2-pyrrolidone, and N-ethyl-2-pyrrolidone; hydrocarbons such as toluene, xylene, n-pentane, n-hexane, and cyclohexane; esters such as ethyl acetate and butyl acetate; ethers such as ethylene glycol monomethyl ether and propylene glycol monomethyl ether; amides such as dimethylacetamide, N,N-dimethylformamide, N,N-dimethylformamide, dimethylacrylamide, acryloylmorpholine, and diethylacrylamide; and amines such as triethylamine, tributylamine, N,N-dimethylaniline, pyridine, and picoline.

A known method may be used for the replacement. For example, the replacement with the other organic solvent may be performed by the evaporation method using a rotary evaporator or the like, or the ultrafiltration method using an ultrafiltration membrane.

### [Composite Material]

The composite material according to the present invention is a composite material including the silica particle dispersion according to the present invention and an organic resin material.

The organic resin material may be selected from at least one selected from the group consisting of polyethylene resins, polypropylene resins, polystyrene resins, acrylic resins, methacrylic resins, urethane resins, urethane acrylate resins, urethane methacrylate resins, polycarbonate resins, ABS resins, diallyl phthalate, and unsaturated polyesters.

While the method for producing the composite material is not particularly limited, the composite material may be obtained by, for example, mixing the silica particle dispersion and a monomer or polymer solution of the organic resin material to prepare a polymerizable composition, and then removing excess solvent, followed by photo- or thermal curing. The composite material can also be obtained by removing the dispersion medium from the silica particle dispersion to obtain a powder of the surface-treated silica particles, adding the powder to a monomer or polymer solution of the organic resin material to prepare a polymerizable composition, removing excess solvent, and then photo- or thermal curing the composition.

The mixing ratio of the silica particle dispersion to the monomer or polymer solution of the organic resin material in the polymerizable composition may be such that the mass ratio of the surface-treated silica particles in the silica particle dispersion to the monomer or polymer of the organic resin material, i.e., surface-treated silica particles: monomer or polymer of the organic resin material, is 1:100 to 0.1, for example, 1:20 to 0.1.

The polymerizable composition can be cured with light or heat by using a polymerization initiator. Examples of photopolymerization initiators include photoradical polymerization initiators or photo-cationic polymerization initiators, and examples of thermal polymerization initiators include thermal radical polymerization initiators or thermal cationic polymerization initiators. The polymerization initiator may be used in an amount of 0.01 parts by mass to 50 parts by mass relative to 100 parts by mass of the polymerizable compound.

In addition, as optional components, conventional additives used in prior art polymerizable compositions (composite materials), for example, various additives used in the relevant technical field, such as pigments and catalysts for curing acceleration, radical scavengers (quenchers), leveling agents, viscosity modifiers, antioxidants, ultraviolet absorbers, stabilizers, plasticizers, and surfactants, may be mixed and used.

By selecting an appropriate organic resin material according to the application, the composite material of the present invention can be used as a semiconductor device material, a copper-clad laminate, a flexible wiring material, a flexible display material, an antenna material, an optical wiring material, or a sensing material.

### [Composition]

The present invention is also directed to a composition including the silica particle dispersion, a photosensitive resin, and a photopolymerization initiator. As used herein, the photosensitive resin refers to a resin material that can be photocured among the organic resin materials, i.e., an ultraviolet curable resin.

Examples of the ultraviolet curable resin include acrylic resins, methacrylic resins, urethane acrylate resins, and urethane methacrylate resins. More specifically, examples include a polymer of a monofunctional (meth)acrylate having one group (hereinafter may referred to as a (meth)acryloyloxy group) selected from the group consisting of an acryloyloxy group (CH₂═CH—COO—) and a methacryloyloxy group (CH₂═C(CH₃)—COO—) in the molecule; a polymer of a polyfunctional (meth)acrylate having two or more (e.g., two or more and six or less) (meth)acryloyloxy groups in the molecule; and a polymer of a monofunctional or polyfunctional urethane (meth)acrylate additionally having a urethane bond in the (meth)acryloyloxy group(s); or a polymer of a mixture thereof.

Examples of the ultraviolet curable resin also include epoxy resins.

In one embodiment, the present invention is directed to a composition including the silica particle dispersion, for example, one or more resins selected from acrylic resins, methacrylic resins, urethane acrylate resins, and urethane methacrylate resins as photosensitive resin(s), and a photoradical polymerization initiator.

In another embodiment, the present invention is directed to a composition including the silica particle dispersion, for example, an epoxy resin as a photosensitive resin, and a photo-cationic polymerization initiator.

In the composition, the mixing ratio of the silica particle dispersion to the photosensitive resin and the proportion of the photopolymerization initiator incorporated, as well as the optional components, and the like may be, for example, the conditions, the components, and the like mentioned in [Composite Material] above.

As described above, in the formation of a composite between the surface-treated silica particles and another resin material, any change in the treated state of the surfaces of the silica particles (the amount of the bonded surface treatment agent or the type of surface treatment group), i.e., any change in the condition of the particle interface, may cause a change over time in the compatibility with the resin material, and further, poor uniformity of the composite material.

For example, it is theoretically desirable that all of the surface treatment agent used in the surface treatment is subjected to the surface treatment; however, in reality, some of the surface treatment agent may remain in the dispersion of the surface-treated silica particles, and the remaining surface treatment agent may, for example, bond to the silica particles over time, resulting in a change in the amount of surface treatment from that immediately after the treatment.

This can lead to variations in the physical properties of the cured product (product), such as hardness, when formed into a composite material.

Furthermore, for example, when the surface treatment agent contains double bond moieties, if the proportion of the double bond moieties at the particle interface changes due to a loss of the double bond moieties or variations in the amount of treatment with the surface treatment agent itself, this can lead to variations in performance such as adhesion.

The present inventors have focused on potential effects of this quality stability of the surface-treated silica particles on variations in the properties of the composite material, and completed the present invention to provide surface-treated silica particles that exhibit little change over time from an initial amount of surface treatment.

### EXAMPLES

The present invention will be hereinafter described in more detail with reference to examples and comparative examples, but the present invention is not limited to the following examples.

The silica sols, surface treatment agent, and basic compounds used in the examples and comparative examples are as follows.

### [Silica Sol]

Methanol-dispersed silica sol A (manufactured by Nissan Chemical Corporation, product name: MT-ST, average primary particle diameter (nitrogen adsorption method): 12 nm, silica concentration 30% by mass)
Methanol-dispersed silica sol B (manufactured by Nissan Chemical Corporation, product name: MA-ST-S, average primary particle diameter (nitrogen adsorption method): 9 nm, silica concentration 20% by mass)
Methanol-dispersed silica sol C (manufactured by Nissan Chemical Corporation, product name: MA-ST-M, average primary particle diameter (nitrogen adsorption method): 22 nm, silica concentration 40% by mass)
Methanol-dispersed silica sol D (manufactured by Nissan Chemical Corporation, product name: MA-ST-L, average primary particle diameter (nitrogen adsorption method): 45 nm, silica concentration 40% by mass)

### [Surface Treatment Agent]

MPS: 3-methacryloxypropyltrimethoxysilane (manufactured by Shin-Etsu Chemical Co., Ltd., product name: KBM-503)

### [Basic Compound]

Basic compound a: sodium hydroxide (Kanto Chemical Co., Inc., product name: 4 mol/L sodium hydroxide solution, product number: 37845-08)
Basic compound b: sodium methoxide (Junsei Chemical Co., Ltd., product name: sodium methoxide 28% solution in methanol, product number: 51055-1601)

Physical properties of the methanol-dispersed silica sols A to D, dispersions of surface-treated silica particles prepared in the examples and comparative examples, and silica sols and dispersions during the dispersion production process were measured and evaluated according to the following methods.

### [Measurement of Silica Concentration]

The silica concentration in each silica sol or dispersion of surface-treated silica particles was calculated by placing the silica sol or dispersion in a crucible, removing the solvent by heating, calcining at 1000° C., and measuring the content of calcination residue.

### [Method for Measuring pH of Silica Sol Dispersed in Organic Solvent]

The pH during the production process of each surface-treated silica particle dispersion was measured for a liquid of mixture of the methanol-dispersed silica sol, methanol, and pure water in a mass ratio of 1:1:1, using a pH meter (MM-43X, manufactured by DKK-Toa Corporation). The pH measured by this method was designated as pH (1+1+1). The measured results of pH (1+1+1) measured in the examples and comparative examples were expressed as follows:

$$pH ( 1 + 1 + 1 ) < 3. : acidic$$

$$3. \leq pH ( 1 + 1 + 1 ) < 6. : weakly acidic$$

$$6. \leq pH ( 1 + 1 + 1 ) \leq 8. : neutral$$

$$8. < pH ( 1 + 1 + 1 ) \leq 11. : weakly alkaline$$

$$11. < pH ( 1 + 1 + 1 ) : alkaline$$

### [Viscosity Measurement]

The viscosity of each surface-treated silica particle dispersion was measured using an Ostwald viscometer (manufactured by Sibata Scientific Technology Ltd.).

### [Amount of Decomposition Product of Surface Treatment Agent]

After preparation of surface-treated silica particles (methanol dispersion), the surface-treated silica particles were stored at 50° C. for two weeks or at room temperature (20 to 25° C.) for 12 weeks, and then the amount of a decomposition product derived from the surface treatment agent in the dispersion was quantified by gas chromatography (GC-2014s; Shimadzu Corporation).

### [Gas Chromatography Conditions]

Column: 3 mm×1 m glass column
Packing material: Porapack Q (GL Sciences Inc.)
Column temperature: 130 to 230° C. (heating rate: 8° C./min)
Carrier: N₂ 40 mL/min
Detector: FID
Injection volume: 1 μL
Internal standard: acetonitrile

### [Decomposition Rate of Surface Treatment Agent]

The decomposition rate of the surface treatment agent in each silica particle dispersion was calculated from the amount of a decomposition product derived from the surface treatment agent in the silica particle dispersion (C, unit: % by mass) quantified in [Amount of Decomposition Product of Surface Treatment Agent], the molecular weight of the surface treatment agent (D, unit: g/mol), the molecular weight of the decomposition product (E, unit: g/mol), and the amount of the surface treatment agent added (proportion in the silica particle dispersion: F, unit: % by mass), according to the following Formula (2). In the examples, the decomposition rate was determined assuming that the decomposition product derived from the surface treatment agent (MPS) was methacrylic acid.

$$decomposition rate of the surface treatment agent = [ C \times ( D / E ) \div F ] \times 100 [ \% ] \qquad Formula ( 2 )$$

### [Measurement of Amount of Particle Surface Treatment]

The amount of surface treatment of the silica particles with the surface treatment agent was calculated by the following procedure:
(1) A 30-cc centrifuge tube was charged with 3 mL of the organic solvent silica sol, and a poor solvent was added thereto.
(2) After centrifuging, the supernatant in which unbonded surface treatment agent was dissolved was removed.
(3) A good solvent was added to redissolve the gel, and then a poor solvent was added, and (2) was performed.
(4) (2) to (3) were performed again.
(5) The resulting gel was vacuum dried, and the resulting powder was then ground in a mortar and dried at 150° C. for 2 hours. The carbon content in this dry powder was measured using an elemental analyzer.

From the obtained carbon content, the amount of treatment with the surface treatment agent bonded to the particle surface was quantified.

### [Calculation of Change Rate Over Time in Amount of Particle Surface Treatment]

The surface-treated silica particles were stored at room temperature (20 to 25° C.) for x weeks after synthesis. Then, the initial (after one week) amount of particle surface treatment (A) and the amount of particle surface treatment after x weeks from the synthesis (B) were measured. The change rate over time in amount of particle surface treatment was calculated according to the following Formula (1):

$$change rate over time in amount of \\ particle surface treatment = [ ( B - A ) / A ] \times 100 [ \% ] \qquad Formula ( 1 )$$

### Example 1-1

Step (i): A 3-liter recovery flask was charged with 2,700 g of the methanol-dispersed silica sol A, and MPS was added, while stirring with a magnetic stirrer, in an amount such that the number of molecules per nm² of the surface area of the silica particles as determined by the nitrogen adsorption method was 1.3, and the mixture was heated to 60° C. and maintained at this temperature for 1 hour.
Step (ii): Thereafter, a basic compound a diluted with methanol was added to adjust the pH (1+1+1) to neutral (6 to 8), and the mixture was heated to 60° C. and maintained at this temperature for 1 hour.
Step (iii): Thereafter, MPS was further added in an amount such that the number of molecules per nm² of the surface area of the silica particles was 0.5, and the mixture was heated to 60° C. and maintained at this temperature for 1 hour to prepare a methanol dispersion of the surface-treated silica particles.

The total amount of MPS added in steps (i) to (iii) was 1.8 molecules per nm² of the surface area of the silica particles in the sol. The resulting methanol dispersion of the surface-treated silica particles had a silica concentration of 30.0% by mass, a water content of 1.6% by mass, and a viscosity of 2.1 mPa-s.

### Example 1-2

A methanol dispersion of the surface-treated silica particles was prepared by performing the same operations as in steps (i) to (iii) of Example 1-1, except that the amount of MPS added in step (i) of Example 1-1 was 1.7 molecules per nm² of the surface area of the silica particles, and the amount of MPS added in step (iii) was 0.6 molecules per nm² of the surface area of the silica particles.

### Example 1-3

A methanol dispersion of the surface-treated silica particles was prepared by performing the same operations as in steps (i) to (iii) of Example 1-1, except that a basic substance b diluted with methanol was added to adjust the pH (1+1+1) to neutral (6 to 8), instead of the basic substance a in step (ii) of Example 1-1.

### Example 1-4

Step (iv): A 3-liter recovery flask was charged with 2,700 g of the methanol-dispersed silica sol A, and MPS was added, while stirring with a magnetic stirrer, in an amount such that the number of molecules per nm² of the surface area of the silica particles as determined by the nitrogen adsorption method was 1.8, and the mixture was heated to 60° C. and maintained at this temperature for 3 hours.
Step (v): Thereafter, a basic compound a diluted with methanol was added to adjust the pH (1+1+1) to neutral (6 to 8), and the mixture was heated to 60° C. and maintained at this temperature for 1 hour.

The resulting methanol dispersion of the surface-treated silica particles had a silica concentration of 30.5% by mass and a water content of 1.5% by mass.

### Example 1-5

Step (vi): A 3-liter recovery flask was charged with 2,700 g of the methanol-dispersed silica sol A, and MPS was added, while stirring with a magnetic stirrer, in an amount such that the number of molecules per nm² of the surface area of the silica particles as determined by the nitrogen adsorption method was 1.8, and the mixture was heated to 60° C. and maintained at this temperature for 6 hours.
Step (vii): Thereafter, a basic compound a diluted with methanol was added to adjust the pH (1+1+1) to neutral (6 to 8), and the mixture was heated to 60° C. and maintained at this temperature for 1 hour.

The resulting methanol dispersion of the surface-treated silica particles had a silica concentration of 30.5% by mass and a water content of 1.5% by mass.

### Example 1-6

A methanol dispersion of the surface-treated silica particles was prepared by performing the same operations as in steps (i) to (iii) of Example 1-1, except that the methanol-dispersed silica sol B was used instead of the methanol-dispersed silica sol A in step (i) of Example 1-1.

### Example 1-7

A methanol dispersion of the surface-treated silica particles was prepared by performing the same operations as in steps (i) to (iii) of Example 1-1, except that the methanol-dispersed silica sol C was used instead of the methanol-dispersed silica sol A in step (i) of Example 1-1.

### Example 1-8

A methanol dispersion of the surface-treated silica particles was prepared by performing the same operations as in steps (i) to (iii) of Example 1-1, except that the methanol-dispersed silica sol D was used instead of the methanol-dispersed silica sol Ain step (i) of Example 1-1.

### Example 1-9

A methanol dispersion of the surface-treated silica particles was prepared by performing the same operations as in steps (i) to (iii) of Example 1-1, except that in step (i) of Example 1-1, MPS was added in an amount such that the number of molecules per nm² of the surface area of the silica particles was 0.7 molecules, instead of 1.3 molecules, and in step (iii), MPS was added in an amount such that the number of molecules per nm² of the surface area of the silica particles was 0.2 molecules, instead of 0.5 molecules.

### Example 1-10

A methanol dispersion of the surface-treated silica particles was prepared by performing the same operations as in steps (i) to (iii) of Example 1-1, except that in step (i) of Example 1-1, MPS was added in an amount such that the number of molecules per nm² of the surface area of the silica particles was 1.0 molecule, instead of 1.3 molecules, and in step (iii), MPS was added in an amount such that the number of molecules per nm² of the surface area of the silica particles was 0.4 molecules, instead of 0.5 molecules.

### Example 1-11

A 3-liter recovery flask was charged with 2,700 g of the methanol-dispersed silica sol A, and the methanol-dispersed silica sol A was concentrated to a silica concentration of 35% by mass while stirring with heating at 70° C., using an evaporator.

Thereafter, the same operations as in steps (i) to (iii) of Example 1-1 were performed to prepare a methanol dispersion of the surface-treated silica particles.

Thereafter, the methanol dispersion of the surface-treated silica particles was further concentrated while stirring with heating at 70° C., using an evaporator, until the silica concentration reached 40% by mass or more.

The resulting methanol dispersion of the surface-treated silica particles had a silica concentration of 40.3% by mass, a water content of 1.7% by mass, and a viscosity of 3.8 mPa-s.

### Example 1-12

A methanol dispersion of the surface-treated silica particles was prepared as in Example 1-1.

Thereafter, the recovery flask containing the methanol dispersion of the surface-treated silica particles was placed in a rotary evaporator, and distillation was performed while supplying methyl ethyl ketone at a bath temperature of 80° C. and a reduced pressure of 600 to 400 Torr, until the water content in the dispersion was reduced to 1.0% by mass or less, so that replacement of the dispersion medium from methanol to methyl ethyl ketone was achieved, thus obtaining a methyl ethyl ketone dispersion of the surface-treated silica particles.

The resulting methyl ethyl ketone dispersion of the surface-treated silica particles had a silica concentration of 30.4% by mass, a water content of 0.1% by mass, and a viscosity of 1.1 mPa-s.

### Comparative Example 1-1

A methanol dispersion of the surface-treated silica particles was prepared by performing the same operations as in steps (i) to (iii) of Example 1-1, except that in step (ii) of Example 1-1, the basic substance a was added to adjust the pH (1+1+1) to weakly alkaline (8 to 11), instead of neutral (6 to 8).

The resulting methanol dispersion of the surface-treated silica particles had a silica concentration of 29.9% by mass, a water content of 1.7% by mass, and a viscosity of 2.1 mPa-s.

### Comparative Example 1-2

A methanol dispersion of the surface-treated silica particles was prepared by performing the same operations as in steps (i) to (iii) of Example 1-1, except that the amount of MPS added in step (i) of Example 1-1 was 1.7 molecules per nm² of the surface area of the silica particles; the basic substance a was added in step (ii) to adjust the pH (1+1+1) to weakly alkaline (8 to 11), instead of neutral (6 to 8); and the amount of MPS added in step (iii) was 0.6 molecules per nm² of the surface area of the silica particles.

The resulting methanol dispersion of the surface-treated silica particles had a silica concentration of 29.8% by mass, a water content of 1.6% by mass, and a viscosity of 2.1 mPa-s.

### Comparative Example 1-3

A methanol dispersion of the surface-treated silica particles was prepared by performing the same operations as in Examples 1-1 and 1-3, except that in step (i) of Example 1-1, 181 g of the methanol-dispersed silica sol A and 2,592 g of the methanol-dispersed silica sol D were charged instead of 2,700 g of the methanol-dispersed silica sol A; in step (ii) of Example 1-3, the basic substance b diluted with methanol was added to adjust the pH (1+1+1) to weakly acidic (3 to 6), instead of adding the basic substance b diluted with methanol to adjust the pH (1+1+1) to neutral (6 to 8); and the amount of MPS added in step (iii) of Example 1-1 was 1.2 molecules, instead of 1.3 molecules, per nm² of the surface area of the silica particles.

### Comparative Example 1-4

Step (viii): A 3-liter recovery flask was charged with 2,700 g of the methanol-dispersed silica sol A, and the basic compound a diluted with methanol was added, while stirring with a magnetic stirrer, to adjust the pH (1+1+1) to neutral (6 to 8), and the mixture was heated to 60° C. and maintained at this temperature for 1 hour.
Step (ix): Thereafter, MPS was added in an amount such that the number of molecules per nm² of the surface area of the silica particles as determined by the nitrogen adsorption method was 1.8, and the mixture was heated to 60° C. and maintained at this temperature for 3 hours to prepare a methanol dispersion of the surface-treated silica particles.

The resulting methanol dispersion of the surface-treated silica particles had a silica concentration of 29.8% by mass, a water content of 1.8% by mass, and a viscosity of 2.7 mPa-s.

### Example 2-1

The methanol dispersion of the surface-treated silica particles obtained in Example 1-1 was stored at 50° C. for two weeks after preparation, and the amount of a decomposition product of the surface treatment agent was then measured by gas chromatography. Methyl methacrylate was detected as the decomposition product of MPS (detected as a reaction product between methacrylic acid and methanol as the dispersion medium).

The decomposition rate of the surface treatment agent was calculated according to the following Formula (2). In the Formula (2), the amount of the decomposition product derived from the surface treatment agent in the silica particle dispersion is defined as (C, unit: % by mass), the molecular weight of the surface treatment agent is defined as (D, unit: g/mol), the molecular weight of the decomposition product is defined as (E, unit: g/mol), and the amount of the surface treatment agent added (proportion of the surface treatment agent in the system) is defined as (F, unit: % by mass).

$$decomposition rate of the surface treatment agent = [ C \times ( D / E ) \div F ] \times 100 [ \% ] \qquad Formula ( 2 )$$

Table 1 shows the decomposition rate of the surface treatment agent in the methanol dispersion of the surface-treated silica particles obtained in Example 1-1. In Table 1, a decomposition rate of 2% or less is evaluated as OK, and a decomposition rate of 2% or more is evaluated as NG.

### Examples 2-2 and 2-3, and Comparative Examples 2-1 and 2-2

Regarding the decomposition rate of the surface treatment agent in each of the methanol dispersions of the surface-treated silica particles obtained in Examples 1-2 and 1-3, and Comparative Examples 1-1 and 1-2, the methanol dispersion of the surface-treated silica particles was stored at 50° C. for two weeks after preparation, and the amount of the decomposition product of the surface treatment agent was then measured as in Example 2-1, and the decomposition rate of the surface treatment agent was calculated. Table 1 shows the decomposition rates of the surface treatment agent in the methanol dispersions of the surface-treated silica particles obtained in Examples 1-2 and 1-3, and Comparative Examples 1-1 and 1-2.

### Comparative Example 2-3

The methanol dispersion of the surface-treated silica particles obtained in Example 1-1 was stored at room temperature (20 to 25° C.) for 12 weeks after preparation, and the amount of the decomposition product of the surface treatment agent was then measured as in Example 2-1, and the decomposition rate of the surface treatment agent was calculated. Table 1 shows the decomposition rate of the surface treatment agent in the methanol dispersion of the surface-treated silica particles obtained in Comparative Example 2-3.

### Example 3-1

The methanol dispersion of the surface-treated silica particles obtained in Example 1-1 was stored at room temperature (20 to 25° C.), and the amounts (% by mass) of particle surface treatment from the 1st week (initial, x=1) to the 14th week (x=14) were calculated from the carbon content values quantified using an elemental analyzer. In addition, the initial MPS reaction rate was determined from the initial (after one week) amount of surface treatment and the amount of MPS added (proportion in % by mass of MPS in the system). Furthermore, the change rate over time in amount of particle surface treatment was calculated from the initial (after one week) amount of particle surface treatment (A) and the amount of particle surface treatment after x weeks from the synthesis (B), according to the following Formula (1):

$$change rate over time in amount of \\ particle surface treatment = [ ( B - A ) / A ] \times 100 [ \% ] \qquad Formula ( 1 )$$

The change rate over time in amount of particle surface treatment in Example 1-1 was at most 13.6% (x=14). Table 2 shows the initial (after one week) amount of surface treatment, the MPS reaction rate, and the state of change over time after x weeks. The threshold for the state of change over time in surface was set at 20%, with less than 20% being evaluated as “◯” and 20% or more being evaluated as “x”.

### Examples 3-2 and 3-3, and Comparative Example 3-1

The methanol dispersions of the surface-treated silica particles obtained in Examples 3-2 and 3-3, and Comparative Example 3-1 were stored at room temperature (20 to 25° C.), and the amounts of particle surface treatment from the 1st week (initial, x=1) to the 14th week (x=14) were measured as in Example 3-1, and the MPS reaction rate and the change rate over time were calculated. Table 2 shows the initial (after one week) amount of surface treatment, MPS reaction rate, and state of change over time after x weeks, for each of the methanol dispersions of the surface-treated silica particles obtained in Examples 3-2 and 3-3, and Comparative Example 3-1.

TABLE 1
Evaluation of Decomposition Rate

| | | | | Storage Conditions | Decomposition Rate | |
|---|---|---|---|---|---|---|
| | | Basic | | before Measurement | (%) of Surface | |
| Classification | | Compound | pH (1 + 1 + 1) | (Temperature × Period) | Treatment Agent | Evaluation |
| Example 2-1 | Example 1-1 | a | Neutral | 50° C. × 2 weeks | 0.8 | OK |
| Example 2-2 | Example 1-2 | a | Neutral | 50° C. × 2 weeks | 1.6 | OK |
| Example 2-3 | Example 1-3 | b | Neutral | 50° C. × 2 weeks | 1.9 | OK |
| Comparative | Comparative | a | Weakly Alkaline | 50° C. × 2 weeks | 5.8 | NG |
| Example 2-1 | Example 1-1 | | | | | |
| Comparative | Comparative | a | Weakly Alkaline | 50° C. × 2 weeks | 7.2 | NG |
| Example 2-2 | Example 1-2 | | | | | |
| Comparative | Comparative | b | Acidic | 25° C. × 12 weeks | 2.6 | NG |
| Example 2-3 | Example 1-3 | | | | | |

TABLE 2
Evaluation of Change Rate over Time

| | | Initial Particle Surface | | | | | | | |
|---|---|---|---|---|---|---|---|---|---|
| | | Amount (% by | MPS | State of Change over Time in | | | | | |
| | | mass) of | Reaction | Particle Surface after x Weeks | | | | | |
| Classification | | Treatment | Rate (%) | x = 2 | x = 3 | x = 4 | x = 8 | x = 14 | Evaluation |
| Example 3-1 | Example 1-1 | 3.7 | 63 | ◯ | ◯ | ◯ | ◯ | ◯ | OK |
| Example 3-2 | Example 1-4 | 3.7 | 64 | ◯ | ◯ | ◯ | ◯ | ◯ | OK |
| Example 3-3 | Example 1-5 | 3.6 | 61 | ◯ | ◯ | ◯ | ◯ | ◯ | OK |
| Comparative | Comparative | 3.1 | 53 | ◯ | X | X | X | X | NG |
| Example 3-1 | Example 1-3 | | | | | | | | |

The results in the examples and comparative examples described above are summarized in Table 3.

Regarding the method of adding the surface treatment agent shown in Table 3, the method of addition in steps (i) to (iii) of Example 1-1 is designated as A, the method B of adding the surface treatment agent: the method of addition in steps (iv) to (v) of Example 1-4 is designated as B, the method of addition in steps (vi) to (vii) of Example 1-5 is designated as C, and the method of addition in steps (vi) to (vii) of Comparative Example 1-3 is designated as D.

In Table 3, the evaluation is OK when either the decomposition rate (Table 1) or the change rate over time (Table 2) is evaluated as OK.

TABLE 3

| | | | Surcface-Treated Silica Particle Dispersion | | | | | |
|---|---|---|---|---|---|---|---|---|
| | | | | Amount | | | | |
| | | | | (Molecule(s)/ | | | | |
| | | | Particle | nm²) of Surface | | | Solid | |
| | | | Diameter | Treatment | Basic | pH (1 + | Content | Dispersion |
| Classification | | | (nm) | Agent Added | Compound | 1 + 1) | (%) | Medium |
| Example 3-1 | Example 2-1 | Example 1-1 | 12 | 1.8 | a | Neutral | 30 | Methanol |
| — | Example 2-2 | Example 1-2 | 12 | 2.3 | a | Neutral | 30 | Methanol |
| — | Example 2-3 | Example 1-3 | 12 | 1.8 | b | Neutral | 30 | Methanol |
| Example 3-2 | — | Example 1-4 | 12 | 1.8 | a | Neutral | 30 | Methanol |
| Example 3-3 | — | Example 1-5 | 12 | 1.8 | a | Neutral | 30 | Methanol |
| — | — | Example 1-6 | 9 | 1.8 | a | Neutral | 20 | Methanol |
| — | — | Example 1-7 | 22 | 1.8 | a | Neutral | 40 | Methanol |
| — | — | Example 1-8 | 45 | 1.8 | a | Neutral | 40 | Methanol |
| — | — | Example 1-9 | 12 | 0.9 | a | Neutral | 30 | Methanol |
| — | — | Example 1-10 | 12 | 1.4 | a | Neutral | 30 | Methanol |
| — | — | Example 1-11 | 12 | 1.8 | a | Neutral | 40 | Methanol |
| — | — | Example 1-12 | 12 | 1.8 | a | Neutral | 30 | MEK |
| — | Comparative | Comparative | 12 | 1.8 | a | Weakly | 30 | Methanol |
| | Example 2-1 | Example 1-1 | | | | Alkaline | | |
| — | Comparative | Comparative | 12 | 2.3 | a | Weakly | 30 | Methanol |
| | Example 2-2 | Example 1-2 | | | | Alkaline | | |
| — | Comparative | Comparative | 40 | 2.5 | b | Acidic | 35 | Methanol |
| | Example 2-3 | Example 1-3 | | | | | | |
| Comparative | — | Comparative | 12 | 1.8 | a | Neutral | 30 | Methanol |
| Example 3-1 | | Example 1-3 | | | | | | |

| | | | | Structural Analysis | | |
|---|---|---|---|---|---|---|
| | | | Method of | Decomposition | Change Rate | |
| | | | Adding | Rate of Surface | over Time in | |
| | | | Surface | Treatment | Particle | |
| | | | Treatment | Agent | Surface | |
| Classification | | | Agent | (Table 1) | (Table 2) | Evaluation |
| Example 3-1 | Example 2-1 | Example 1-1 | A | OK | OK | OK |
| — | Example 2-2 | Example 1-2 | A | OK | — | OK |
| — | Example 2-3 | Example 1-3 | A | OK | — | OK |
| Example 3-2 | — | Example 1-4 | B | — | OK | OK |
| Example 3-3 | — | Example 1-5 | C | — | OK | OK |
| — | — | Example 1-6 | A | — | — | OK* |
| — | — | Example 1-7 | A | — | — | OK* |
| — | — | Example 1-8 | A | — | — | OK* |
| — | — | Example 1-9 | A | — | — | OK* |
| — | — | Example 1-10 | A | — | — | OK* |
| — | — | Example 1-11 | A | — | — | OK* |
| — | — | Example 1-12 | A | — | — | OK* |
| — | Comparative | Comparative | A | NG | — | NG |
| | Example 2-1 | Example 1-1 | | | | |
| — | Comparative | Comparative | A | NG | — | NG |
| | Example 2-2 | Example 1-2 | | | | |
| — | Comparative | Comparative | A | NG | — | NG |
| | Example 2-3 | Example 1-3 | | | | |
| Comparative | — | Comparative | D | — | NG | NG |
| Example 3-1 | | Example 1-3 | | | | |

*Both the decomposition rate and the change rate over time were evaluated as OK, based on the production conditions.

As shown in Table 3, it was confirmed that the dispersions of the neutral surface-treated silica containing MPS and an alkali metal, and the dispersions of the surface-treated silica obtained by the methods A, B, and C of adding the surface treatment agent are each stable in terms of the structure of the surface treatment agent or the structure of the silica particle surface, and each exhibit an excellent quality or excellent supply stability.

In contrast, it was confirmed that the dispersions of the weakly acidic or weakly alkaline surface-treated silica containing MPS and an alkali metal, and the dispersion of the surface-treated silica obtained by the method D of adding the surface treatment agent are each unstable in terms of the structure of the surface treatment agent or the structure of the silica particle surface, and each present concerns with supply stability in terms of quality.

As used herein, the term “supply stability” means the ability to supply a dispersion of surface-treated silica of stable quality, in which the surface-treated silica particles experience little change in the interface state of the silica particles, such as change in the amount of the bonded surface treatment agent (amount of treatment) or change in the structure of the surface treatment group. This is one of the important properties that can further lead to the provision of a material that is homogeneous in terms of compatibility with a resin material in the formation of a composite therewith, physical properties such as hardness of the material obtained after composite formation, and properties such as adhesion.

1. A silica particle dispersion in which surface-treated silica particles are dispersed in an organic solvent,
wherein the surface-treated silica particles are silica particles surface-treated with a surface treatment agent including an alkoxysilane containing a radically polymerizable double bond and an ester group, and
wherein in the dispersion,
a change rate over time in amount of particle surface treatment with the surface treatment agent as defined by the following Formula (1) is less than 20%, and
a decomposition rate of the surface treatment agent as defined by the following Formula (2) is 2.0% or less:
$$〈 Change Rate [ \% ] over Time in Amount of Particle Surface Treatment 〉$$
$$change rate over time in amount of \\ particle surface treatment = [ ( B - A ) / A ] \times 100 [ \% ] \qquad Formula ( 1 )$$
in Formula (1),
A is an amount of particle surface treatment after one week of storage at room temperature (20 to 25° C.), following preparation of the silica particle dispersion; and
B is an amount of particle surface treatment after 14 weeks of storage at room temperature (20 to 25° C.), following preparation of the silica particle dispersion;
$$〈 Decomposition Rate [ \% ] of Surface Treatment Agent 〉$$
$$decomposition rate of the surface treatment agent = [ C \times ( D / E ) \div F ] \times 100 [ \% ] \qquad Formula ( 2 )$$
C is an amount (% by mass) of a decomposition product derived from the surface treatment agent in the silica particle dispersion after at least two weeks of storage at room temperature (20 to 25° C.) to 50° C., following preparation of the silica particle dispersion, in which the decomposition product includes a radically polymerizable double bond-containing carboxylic acid and a derivative of the radically polymerizable double bond-containing carboxylic acid;
D is a molecular weight (g/mol) of the surface treatment agent;
E is a molecular weight (g/mol) of the decomposition product; and
F is an amount (proportion in % by mass in the silica particle dispersion) of the surface treatment agent added during surface treatment.

2. The silica particle dispersion according to claim 1,
wherein the silica particle dispersion has a pH of 6.5 to 8.0.

3. The silica particle dispersion according to claim 2,
wherein the silica particle dispersion contains a basic substance selected from hydroxide or alkoxide compounds derived from monovalent alkali metals.

4. The silica particle dispersion according to claim 1,
wherein an initial reaction rate between the surface treatment agent and the silica particles is 50% or more, the initial reaction rate being defined as a ratio of the amount of particle surface treatment with the surface treatment agent after one week of storage at room temperature (20 to 25° C.) following preparation of the silica particle dispersion, relative to the amount of the surface treatment agent added during surface treatment.

5. The silica particle dispersion according to claim 1,
wherein the silica particles have an average primary particle diameter of 5 nm or more and less than 100 nm, and
wherein in the silica particle dispersion, a concentration of the surface-treated silica particles is 20 to 70% by mass, and a water concentration is 0.001 to 10% by mass.

6. The silica particle dispersion according to claim 1,
wherein the surface-treated silica particles are surface-treated with the surface treatment agent in an amount of 0.5 to 3.0 molecules per nm² of a surface area of the silica particles.

7. The silica particle dispersion according to claim 1,
wherein the surface treatment agent is an alkoxysilane of the following Formula (a):

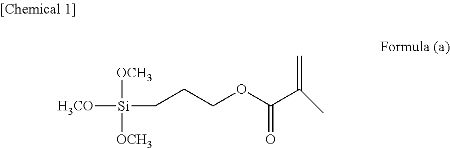 [SMILES: C=C(C)C(=O)OCCC[Si](OC)(OC)OC]

8. The silica particle dispersion according to claim 1,
wherein the organic solvent is at least one organic solvent selected from the group consisting of alcohols, ketones, hydrocarbons, amides, esters, ethers, and amines.

9. A composite material comprising the silica particle dispersion according to claim 1 and an organic resin material.

10. The composite material according to claim 9,
wherein the organic resin material is at least one selected from the group consisting of polyethylene resins, polypropylene resins, polystyrene resins, acrylic resins, methacrylic resins, urethane resins, urethane acrylate resins, urethane methacrylate resins, polycarbonate resins, ABS resins, diallyl phthalate, and unsaturated polyesters.

11. A composition comprising the silica particle dispersion according to claim 1, a photosensitive resin, and a photopolymerization initiator.

12. The composition according to claim 11,
wherein the photosensitive resin is at least one selected from the group consisting of acrylic resins, methacrylic resins, urethane acrylate resins, urethane methacrylate resins, and epoxy resins.

13. A method for producing a silica particle dispersion in which surface-treated silica particles are dispersed in an organic solvent, the method comprising the following steps (A), (B), and (C):
step (A): preparing a silica sol containing silica particles having an average primary particle diameter of 5 nm or more and less than 100 nm as a dispersoid, and a C₁₋₄ alcohol as a dispersion medium;
step (B): adding a surface treatment agent including an alkoxysilane containing a radically polymerizable double bond and an ester group to the silica sol, and stirring a mixture with heating; and
step (C): performing a pH adjustment to give a pH in a system of 6.5 to 8.0, and stirring the mixture with heating.

14. The method for producing a silica particle dispersion according to claim 13, further comprising, after step (C), the following step (D):
step (D): adding a surface treatment agent including an alkoxysilane containing a radically polymerizable double bond and an ester group to the silica sol, and stirring the mixture with heating.

15. The method for producing a silica particle dispersion according to claim 13,
wherein step (C) is the step of performing the pH adjustment by adding a basic substance selected from hydroxide or alkoxide compounds derived from monovalent alkali metals.
